(19) United States
(12) Patent Application Publication
(10) Pub. No.: US 2021/0244168 A1
(43) Pub. Date: Aug. 12, 2021

(54) Portable Multipurpose Utility Container

(71) Applicant: Greg Wawrzyniak, San Diego, CA (US)

(72) Inventor: Greg Wawrzyniak, San Diego, CA (US)

(21) Appl. No.: 15/772,565

(22) PCT Filed: Nov. 4, 2016
(86) PCT No.: PCT/US16/60447

§ 371 Date: Jul. 25, 2019

Related U.S. Application Data
(60) Provisional application No. 62/285,719, filed on Nov. 5, 2015.
(60) Provisional application No. 62/391,545, filed on May 3, 2016.

(51) Int. Cl. A45F 5/02; B65D 25/22; B25H 3/02

(52) U.S. Cl. CPC A45F 5/021; B65D 25/22; A45F 2005/008; A45F 2200/0575; B25H 3/02

(57) ABSTRACT

The present invention is a portable multipurpose utility container comprising at least one compartment or reservoir and a flat handle extending outwardly forming a horizontal or arched wrist support with an aperture for gripping with the thumb or finger. The reservoir has a base, a distal wall, a proximal wall, a left side wall and a right side wall. The reservoir is sized to receive, contain and/or dispense fluids or compounds and to accommodate a variety of hand tools and hardware. The flat handle extends outwardly from the top of the proximal wall, forming a horizontal or arched wrist support section extending outwardly and downwardly having at least one aperture about midway along its length and a locking means near its end for securing said portable utility container during use. The arched wrist support section has a depth greater than the diameter of the wrist of a user and the at least one aperture is sized and ergonomically positioned to accommodate a thumb or one or more fingers of the user's hand for securing the device during use.

### CROSS-REFERENCE TO RELATED APPLICATIONS

This patent application claims priority to U.S. provision. patent application Ser. No. 62/285,719 filed on 5 Nov. 2015 and U.S. provisional patent application Ser. No. 62/391,545 filed 3 May 2016 which is incorporated herein by reference in its entirety.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates generally to containers used in construction for carrying liquids such as paint, stain or lacquer or other semi-fluid compounds such as glue, leveling compound, drywall joint compound, spackling paste, wood putty as well as tools and other hardware. More specifically, the device relates to an easily hand held device for maintaining fluids or other semi-fluid compounds, tools or hardware for use during construction and building repair and/or maintenance.

### BACKGROUND OF THE INVENTION

Commonly used paint trays or containers are designed to contain a certain amount of paint and to provide an area to distribute the paint evenly onto a paint roller or brush. The size of a conventional paint tray or container is designed to receive a correspondingly sized paint roller or brush. However the size and shape of commercially available paint trays, when filled to capacity, does not allow them to be moved without great risk of spill.

Correspondingly, the use of a paint container is difficult to manage when the container is placed at a distance from the user and multiple trips are required to obtain a sufficient amount of paint to complete the job. Many times painting must be performed with equipment that elevate the user, such as a ladder. The common remedy when using a ladder, practiced among professionals and amateurs alike, is using a nearly empty paint can, paint can cover or a small container filled with paint when touching-up all the “hard-to-reach” places. However, this is not a solution, since accessing those “hard-to-reach” areas with a paint brush while holding a paint container in your hands, is not only very cumbersome but also dangerous.

While this is true for painting, these problems can also arise when repairing or placing drywall, hanging wall paper, cleaning windows, applying a stain or lacquer or other types of repairs that may require liquids or similar substances, tools and hardware with the use of a ladder.

As such, there is a continuing unmet need for a container that does not completely restrict the use of the hands while performing these types of tasks not only when utilizing a ladder but also in general.

The forgoing examples of related art and limitations related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described is a portable multiuse utility container. One aspect of the present invention is a portable utility container that comprises at least one compartment or reservoir having a handle extending outwardly forming a horizontal or arched wrist support with an aperture for gripping with the thumb or finger. The at least one compartment or reservoir has a base, a distal wall, a proximal wall, a left side wall and a right side wall and is sized to receive or contain and/or dispense a substance or substances and able to accommodate a variety of hand tools and hardware. The handle extends outwardly from the top of the proximal wall and has a horizontal or arched wrist support section extending outwardly and downwardly with at least one aperture about midway along its length and a locking means near the end for securing the portable utility container when not in the hands of a user. The arched wrist support section has a depth greater than the diameter of the wrist of the user and the at least one aperture is sized and positioned to ergonomically accommodate a thumb or one or more digits of the user's hand for securing the portable utility container in a desired position during use.

A second aspect of the present invention is a portable multipurpose utility container that comprises at least one compartment or reservoir having an arched wrist support with a flat handle having an aperture about its center for gripping with a thumb or finger. The at least one compartment or reservoir has a base, a distal wall, a proximal wall, a left side wall and a right side wall and is sized to receive or contain and/or dispense a substance or substances and able to accommodate a variety of hand tools and hardware. The arched wrist support extends outwardly and downwardly from the top of the proximal wall and is connected to at least one flat handle having at least one aperture about its center. The arched wrist support section has a depth greater than the diameter of a wrist of a user and the at least one aperture is sized and positioned to ergonomically accommodate a thumb or one or more digits of the user's hand for securing the portable utility container in a desired position during use.

A third aspect of the present invention is a portable multipurpose utility container liner that comprises at least one compartment or reservoir able to receive, having a lip that can be folded over to cover the top of the compartment or reservoir. The at least one compartment or reservoir has a base, a distal wall, a proximal wall, a left side wall and a right side wall and is able to contain and/or dispense a substance or substances and to accommodate a variety of hand tools and hardware. The lip is preferably connected to the distal wall and able to cover the top of the compartment or reservoir to reduce spillage or drying of the contents during use or storage.

A forth aspect of the present invention is a flexible portable multipurpose utility container that comprises at least one compartment or reservoir with a flat handle having an aperture about its center for gripping with a thumb or finger and able to receive a portable multipurpose utility container liner. The at least one compartment or reservoir has a base, a distal wall and a proximal wall and at least one flat handle connected to the top of the proximal wall. The flat handle has at least one aperture about its center and is sized and positioned to ergonomically accommodate a thumb or one or more digits of a user's hand thereby securing the flexible portable utility container in a desired position during use.

In one embodiment of the first and second aspects of the invention, the distal wall of the portable multipurpose utility container has a lip that may be folded over the top of the compartment or reservoir to reduce spillage from the compartment or reservoir or drying of the contents of the compartment or reservoir during use or storage.

In another embodiment of the first and second aspects of the invention, the portable multipurpose utility container further comprises one or more magnets that are securely fastened to the base and/or walls of the reservoir for securing magnetically susceptible hand tools to the device during use.

In another embodiment of the second, third and fourth aspects of the invention, the flat handle is a series of flat handles connected one to the other and can be folded upon one another to create a single handle or extended to form multiple handles.

In one embodiment of the third aspect of the invention, the portable multipurpose utility container liner may further comprise a cover flap that allows the liner to be closed to reduce spillage of the compartment or reservoir or drying of the contents of the compartment or reservoir during use or storage within the reservoir or when removed from the reservoir. The cover flap has a front edge, a left side edge and a right side edge, wherein each of said front edge, a left side edge and a right side edge may independently have a tab for easy removal of the liner when the liner is inserted into a portable utility container. When the left side edge and/or right side edge of the cover flap have tabs, the tops of the left side wall and right side wall of the portable utility container liner have similar corresponding tabs.

In another embodiment of the third aspect of the invention, the lip may be folded back toward the interior of the compartment or reservoir to form a scraper.

In another embodiment of the first and second aspects of the invention, the portable multipurpose utility container further comprises a scraping element secured or form molded into the top of the distal wall and/or proximal wall. In this configuration, the portable utility container may further comprise a snap clip along either or both the top of the distal wall and/or proximal wall for securing a portable utility container liner in place and for securing a scraping element.

In another embodiment of the second and third aspects of the invention, the base of the proximal wall may further comprise a slot, upside down pocket or sleeve for inserting one of more of the flat handles to form a loop for securing the portable utility container to a ladder, step stool, rain gutter, pipe, saw horse, a length of wood or the like.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

The objects, features, and advantages of the invention will be brought out in the following part of the specification, wherein detailed description is for the purpose of fully disclosing the invention without placing limitations thereon.

### BRIEF DESCRIPTION OF THE DRAWINGS

FIG. 1 is a perspective view of one aspect of the portable multipurpose utility container of the present invention wherein the proximal wall of the compartment or reservoir has an arched wrist support section connected to a flat handle with an aperture about its center.

FIG. 2 is a perspective view of one embodiment of the portable multipurpose utility container of the present invention with three flat handles and side pockets.

FIG. 3 is a perspective view of a portable multipurpose utility container and a portable multipurpose utility container liner and how they might be utilized together.

FIG. 4 is a perspective view of the portable multipurpose utility container of FIG. 2 in which the three flat handles are extended allowing different heights for carrying the device or so that multiple devices may be carried simultaneously.

FIG. 5 is a perspective view of the portable multipurpose utility container of the present invention containing more than one portable multipurpose utility container liner wherein the liners each contain an integral flat handle.

FIG. 6 is a perspective view of one embodiment of the present invention in which the flexible and/or semi-rigid portable multipurpose utility container contains a portable multipurpose utility container liner having a lip that can be folded over and cover the top of the compartment or reservoir of the liner to reduce spillage from the compartment or reservoir or drying of the contents of the compartment or reservoir during use or storage

FIG. 7 is a perspective view of one embodiment of the present invention wherein the flat handle is inserted into the slot, upside down sleeve or pocket on the base of the proximal wall securing the device to a rung of a ladder (dashed line).

FIG. 8 is a perspective view of another aspect of the portable multipurpose utility container of the present invention showing a single handle formed with an arched wrist support section having at least one aperture midway along its length and a locking means near its end.

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “fastened” as used herein with respect to the magnets refers to a variety of methods known to those skilled in the art for securing magnets to a compartment or reservoir similar to that of the present device including fastening one or more magnets to the exterior of compartment or reservoir with adhesive, providing pockets on the exterior of the compartment or reservoir walls for securing the magnets, encasing the magnets within the reservoir or compartment walls or securing a magnet on the compartment or reservoir wall using another magnet on the opposite side of the wall.

The term “connected” as used herein with respect to the series of flat handles refers to a variety of methods known to those skilled in the art for connecting one handle to another, which includes having the one or more handles prepared from a single sheet of material wherein the individual flat handles are separated by a permanent crease allowing one flat handle to fold upon another flat handle and remain attached or connected to one another. This also includes where each of the flat handles is prepared separately and connected to one another along their edge by adhesive, adhesive tape, one or more staples, one or more rivets or other similar means that allows one flat handle to fold upon another flat handle and remain attached or connected to one another.

The term “secured” as used herein with respect to the scraping element refers to a slot, depression or sleeve for retaining a scraper blade when the scraper blade is made of a material other than the material used to prepare the compartment or reservoir. The slot, depression or sleeve contains an element that holds the scraper blade in place such as a snap clip or pressure set. Alternatively, the blade may be secured within the sleeve, depression or slot using adhesive, one or more screws, one or more rivets or other similar device.

One aspect of the present invention herein disclosed and described is a portable multipurpose utility container. The container comprises at least one compartment or reservoir having a flat handle extending outwardly forming a horizontal arched wrist support with an aperture for gripping with the thumb or finger. The at least one compartment or reservoir has a flat bottom, a front wall, a back wall, a left side wall and a right side wall, is sized to receive, contain and/or dispense a substance or substances and able to accommodate a variety of hand tools and hardware. The flat handle extends outwardly from the top of the back wall and has a horizontal or arched wrist support section extending outwardly and downwardly with at least one aperture about midway along its length and a locking means near the end for securing the portable utility container during use. The arched wrist support section has a depth greater than the diameter of the wrist of a user and the at least one aperture is sized and positioned to ergonomically accommodate a thumb or one or more digits of the user's hand for securing the portable utility container in a desired position during use.

A second aspect of the present invention is a portable multipurpose utility container that comprises at least one compartment or reservoir having an arched wrist support with a flat handle having an aperture about its center for gripping with a thumb or finger. The at least one compartment or reservoir has a base, a distal wall, a proximal wall, a left side wall and a right side wall and is sized to receive or contain and/or dispense a substance or substances and able to accommodate a variety of hand tools and hardware. The arched wrist support extends outwardly and downwardly from the top of the proximal wall and is connected to at least one flat handle having at least one aperture about its center. The arched wrist support section has a depth greater than the diameter of a wrist of a user and the at least one aperture is sized and positioned to ergonomically accommodate a thumb or one or more digits of the user's hand for securing the portable utility container in a desired position during use.

A third aspect of the present invention is a portable multipurpose utility container liner that comprises at least one compartment or reservoir able to receive, having a lip that can be folded over to cover the top of the compartment or reservoir. The at least one compartment or reservoir has a base, a distal wall, a proximal wall, a left side wall and a right side wall and is able to contain and/or dispense a substance or substances and to accommodate a variety of hand tools and hardware. The lip is preferably connected to the distal wall and able to cover the top of the compartment or reservoir to reduce spillage or drying of the contents during use or storage.

A forth aspect of the present invention is a flexible portable multipurpose utility container that comprises at least one compartment or reservoir with a flat handle having an aperture about its center for gripping with a thumb or finger and able to receive a portable multipurpose utility container liner. The at least one compartment or reservoir has a base, a distal wall and a proximal wall and at least one flat handle connected to the top of the proximal wall. The flat handle has at least one aperture about its center and is sized and positioned to ergonomically accommodate a thumb or one or more digits of a user's hand thereby securing the flexible portable utility container in a desired position during use.

### The Compartment/Reservoir

In one aspect of the present invention the compartment or reservoir is made of a relatively rigid or semi-rigid material and may be provided in a variety of shapes and sizes. For example, the compartment may be made be made of metal wood or polymer. In certain embodiments, it is preferable that the compartment or reservoir be made of a flexible material such as a polymer that may be easily extruded or form molded into the desired configuration. The compartment or reservoir may be provided in a variety of shapes that include square, rectangular or other shapes that may be beneficial for particular utility (e.g., a rectangular compartment with a flat base and one arched wall bowed outward from the interior of the compartment or a rectangular compartment with a flat base in which the two longer opposing walls are arched in parallel).

In one embodiment, the compartment is provided in a rectangular shape having a length about the length of commercially available paint rollers or about 4 inches, about 5 inches, about 6 inches, about 7, about 8, about 9 about 10, about 11, or about 12 inches for large rollers and a width of about 1.5 times the width of a standard paint roller, or about 3 inches, about 4 inches, about 5 inches or about 6 inches and a height of about twice the thickness of a standard paint roller, or about 5 inches, about 6 inches, about 7 inches, about 8 inches, about 9 inches or about 10 inches to about 12 inches. In one embodiment, the proximal wall is utilized for connection to the wrist support section. This connection may be integral to the entire device as could be the case in the event that the entire device was form molded as a single unit. Alternatively, the wrist support section could be affixed to the compartment or reservoir. This could be accomplished by adhesive, staple, rivet or similar connecting means known in the industry.

In another embodiment, the distal wall is not parallel to the proximal wall but extends outward slightly from the base to the opening of the compartment. Alternatively, this slight angling outward of the distal wall may begin at about one-half the distance from the top of the compartment, about one-third from the top of the compartment, about one-fourth from the top of the compartment or as little as about one-fifth from the top of the compartment. In one embodiment the device has a closable lid that is formed from the inward folding of the top lip of the distal wall inward over the compartment opening. This may be achieved in a variety of ways known in the art. For example, a pre-formed seam may be created in the form molded distal wall about the same distance down from the top lip of the distal wall as the distance between the lip of the distal wall from the lip of the proximal wall. The actual location of the pre-formed seam can be determined by preparing different width sized portions of the distal wall for a given sized compartment or reservoir and folding the lip of the distal wall inwardly toward the proximal wall to determine the distance from the top of the distal wall lip that will effectively close the compartment and then pre-form the crease in the wall for that desired fold. In some embodiments, the lip section formed as part of the distal wall doubles as the closure lid for the compartment.

In another embodiment, the upper edge of the proximal wall and/or the distal wall may further comprise a scraper to remove excess substance from the tool being used for its application. The scraper may be form molded into the top edge of either or both walls and can double as a securing mechanism for maintaining a liner within the compartment. In another configuration, a metal blade may be affixed in the upper edge of the proximal wall and/or the distal wall wherein a form molded slot has been provide for easily clipping in the blade on assembly.

In other embodiments the compartment may further comprise a textured internal surface on the distal wall and/or proximal walls. The texture may be small bumps or ridges to assist in evenly applying paint to a roller or helping to remove excess paint from a brush. A foam or sponge insert may be inserted in the base of the compartment or reservoir to maintain paint in a less spillable form yet still being accessible to a brush or roller. In addition, magnets may be applied to the surface of the device by adhesive, housed in pockets formed in the walls of the device; form molded into one or more walls of the device or affixed one to the other with each being on an opposite side of a surface. A storage slot may be form molded into the base of the proximal wall of the compartment or reservoir or a separate flap adhered to the exterior of the proximal wall to create an upside down sleeve or pocket to receive one or more of the flat handles to form a loop that may be used to secure the device to a ladder rung, a scaffold support, a pipe a fence or other similar support. For additional storage, a pocket affixed to the exterior of the device for holding items such as small tools, drill bits, screws, nails, drywall fasteners, hooks, other supplies and the like. The pocket may be attached to either or both the left side and right side walls, the exterior surface of the distal wall or any combination of these walls.

During use the portable multipurpose utility container of the present invention may contain a variety of substances including for example, water, paint, stain, lacquer, glue, leveling compound, drywall joint compound, spackling paste, wood putty or a cleaning solution. In addition, it may contain a variety of small tools, hardware and/or supplies need to perform a task for which the portable utility container is being utilized.

Another aspect of the compartment or reservoir is made of a flexible polymeric material and have flat handles connected to the top of the proximal wall. In this configuration, the compartment or reservoir has a proximal wall and a distal wall adhered together along three of their four side edges to form a bag. Preferably the bag is in a variety of shapes that include square, rectangular or other shapes that may be beneficial for accepting a portable multipurpose utility container liner. The thickness of the polymer sheet used to prepare the compartment is from about 2 mil to about 8 mil, from about 3 mil to about 5 mil, or about 4 mil. The compartment may have an additional slot or upside down pocket or sleeve on the base of the proximal wall of a size able to receive one or more flat handles. This may be merely an opening along the base seam that secures the base of the distal wall to the base of the proximal wall or it may be an additional piece of polymer that creates the sleeve or pocket. The distal wall, proximal wall and sleeve polymer sheets may be fused together forming the compartment or reservoir as well as the pocket or sleeve by a variety of methods known in the art including heat or adhesive.

### Wrist Support Section

In one embodiment, the wrist support section is a flat or curved surface connecting the compartment or reservoir to the flat handle(s). One side of the wrist support section is connected to the top of and extending relatively perpendicular from the proximal wall with the opposite side connected to the flat handles. The connection between the compartment and the wrist support section is semi-rigid while the connection between the flat handle and the wrist support section is relatively flexible. In one embodiment the connection between the flat handle and the compartment is provided as a preformed crease that allows the flat handle to be bent in about a 350 degree arc about the proximal wall connection.

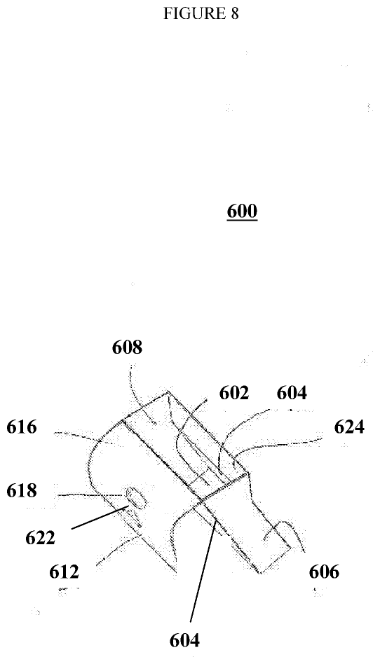

In another embodiment, the flat handle comprises an arched wrist support section extending from the top edge of the proximal wall and continues outwardly and downwardly having at least one aperture about midway along its length with a locking means near the end of the flat handle for securing the device when not in the hands of a user. In this configuration, the handle having the arched wrist support, the aperture and the locking means is a provided in a single piece connected to the top edge of the proximal wall of the compartment or reservoir (see FIG. 8).

The wrist support section may be made in a variety of materials and in a variety of lengths and sizes. For example, the wrist support section may be made of metal wood or polymer. In certain embodiments, it is preferable that the wrist support section be made of a flexible material such as a polymer that may be easily extruded or form molded into the desired configuration. In one particular embodiment the wrist support section is made of the same material as the compartment or reservoir. The length of the wrist support section may encompass the entire length of the top rim of the proximal wall or may connect to only a portion (e.g., the attachment or connection between the wrist support section and the top of the proximal wall may be 100%, about 80%, about 75%, about 50% or about 30% of the length of the top of the proximal wall. The two sides that do not connect the compartment to the flat handles may be straight, curved inward, curved outward or any combination of these configuration as desired by the user.

The distance between the side connected to the proximal wall and the side connected to the flat handles may vary depending on the diameter of an average user's forearm and wrist. When the wrist support section is semi-rigid this distance may range from about 2.5 inches to about 5.5 inches, from 3.0 inches to about 5.0 inches, about 3.5 inches to about 4.5 inches or about 4.0 inches. If the wrist support section is curved becoming generally semi-circular the diameter of the circle formed by the arc may be from about 2.5 inches to about 5.5 inches, from 3.0 inches to about 5.0 inches, about 3.5 inches to about 4.5 inches or about 4.0 inches.

In other embodiments, the wrist support section may be smooth or textured for gripping the upper forearm during use or it may also comprise a cushion to provide comfort during use,

In another embodiment the wrist support section is merely a short extension of the proximal wall connecting the handle to the compartment or reservoir having a length of about the width of a user's wrist. This length of the wrist support section being from about 2 inches to about 7 inches, from about 3 inches to about 6 inches, from about 3.5 to about 5.5 or about 5 inches. In addition, the wrist support section may be made of a different material than the compartment or reservoir. For example, the compartment or reservoir may be made of a semi-rigid polymer and the wriest support section may be made of a fabric affixed to the proximal wall of the compartment or reservoir and acting to connect the one or more flat handles to the device.

### Flat Handle

The device of the present invention may have one or more flat handles flexibly connected to the wrist support section. More specifically, one or more flat handles may be provided on the portable multipurpose utility container in both the semi-rigid and flexible configurations as well as the portable multipurpose utility container liner. The flat handles are provided as a flat sheet of material with one or more apertures for receiving a thumb or one or more fingers of a user and may be provided as a series of flat handles made of a continuous piece of material with pre-creased joints allowing the flat handles to fold one upon the other, they may hinged or they may be connected to each other by a flexible connective material, such as for example a fabric.

In other embodiments, the one or more apertures in the flat handle may have a diameter from about one-half inch to about 3 inches, three-quarters of an inch to about 1.5 inches about 1 inch to about 2 inches or about 1.75 inches and may be circular, oval, egg shaped or other shape that provides comfort during use of the device.

### Liner

In one aspect of the present invention the liner is a removable disposable compartment or reservoir made of a semi-rigid material and provided in a shape and size that allows for the liner to be inserted into a portable multipurpose utility container. For example, the liner is preferably made of a flexible material such as a polymer that may be easily extruded or form molded into the desired configuration. In one embodiment, a wrist support section is affixed or integral to the top of the proximal wall with the other end of the wrist support is connected to a flat handle. This connection may be integral to the liner as could be the case in the event that the liner was form molded as a single unit. Alternatively, the wrist support section could be affixed to top of the proximal wall by adhesive, staples, rivets or other similar connecting means known in the industry.

In another embodiment, a portion of the distal wall may not be parallel to the proximal wall but extends outward. This slight angling outward of the distal wall may begin at about one-half the distance from the top of the compartment, about one-third from the top of the compartment, about one-fourth from the top of the compartment or as little as about one-fifth from the top of the compartment. In one embodiment the liner has a closable lid that is formed from the inward folding of the top lip of the distal wall inward over the compartment opening. This may be achieved in a variety of ways known in the art. For example, a pre-formed seam may be created in the form molded distal wall about the same distance down from the top lip of the distal wall as the distance between the lip of the distal wall from the lip of the proximal wall. The actual location of the pre-formed seam may be determined by preparing different width sized portions of the distal wall for a given sized compartment or reservoir and folding the lip of the distal wall inwardly toward the proximal wall to determine the distance from the top of the distal wall lip that will effectively close the compartment and then pre-form the crease in the wall for that desired fold. In some embodiments, the lip section formed as part of the distal wall doubles as the closure lid for the compartment.

In another embodiment, the upper edge of the proximal wall and/or the distal wall may further comprise a scraper to remove excess substance from the tool being used for its application. The scraper may be form molded into the top edge of either or both walls. In another configuration, the top edge of the proximal wall and/or the distal wall may be folder inwardly toward the interior of the compartment or reservoir to create the scraper. The width of the scraper edge may be from about one-quarter of an inch to about one inch, about three-eighths of an inch to about three quarters of an inch or about one-half inch.

### FIGURES

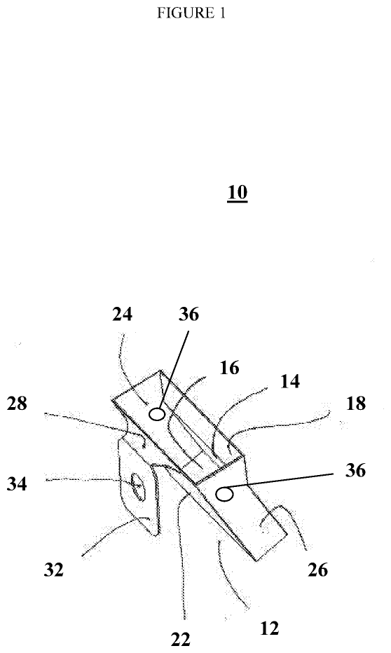

FIG. 1 is a perspective view of one aspect of the portable multipurpose utility container of the present invention 10 in its basic form. Preferably, it is a rather rigid container that includes a relatively deep and narrow rectangular main compartment 12 with the distal wall 14 extending from the base 16 with a portion of its top edge slightly flared outward forming a lip section 18, and the proximal wall 22 extending from the base 16 perpendicularly and substantially higher than the distal wall 14 with its lip section 18. Two narrow side walls, left side wall 24 and right sidewall 26, extend upwardly and slightly outwardly at an at least minimal draft angle from the base 16 to close the cavity and allow nesting of the device 10. The proximal wall 22 terminates at the top where the wrist support section 28 originates and connects by one end to a generally flat handle 32 shown here extending in a downward direction. Flat handle 32 shows a generally round aperture 34 that will have a comfortable feel but at the same time be sufficiently rigid and not bend easily. One or more magnets 36 may be provided on one or both sidewalls, distal wall or proximal wall for securing tools that contain a magnetically susceptible material such as iron. The magnet allows for storing of tools either inside the compartment 12 such as a paint brush which may be positioned on the left or right sidewall of the interior of the compartment 12 just above the paint level to prevent interference with the use of a roller. Alternatively, the same magnet allows for storing of tools on the exterior of the compartment 12 such as a putty knife. During use, the wrist support section 28 rests over the user's wrist and hand. The flat handle 32 has a round aperture 34 in the center through which user's thumb is inserted, providing securement and control of device 10 by hand, while leaving thumb and all fingers free to grasp objects or to hold on to a ladder.

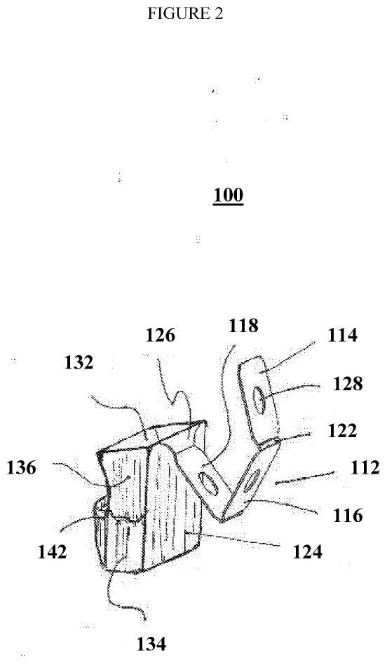

FIG. 2 is a perspective view of another embodiment of the portable multipurpose utility container of the present invention 100 with a multiple flat handle configuration 112 composed of flat handles 114, 116 and 118 connected to each other via flexible joints or connectors 122 with flap 118 attached to the top edge of the proximal wall 124 via wrist support section 126. Each flap is identical in size and has a generally round aperture 128. The compartment or reservoir opening 132 is sized and profiled to receive matching portable multipurpose container liners. The device 100 may also comprise a side pocket 134 attached to the left and/or right side walls 136 and/or 138, to both the left sidewall 136 and right sidewall 138 to provide a pocket along the front or along the front and sides 142.

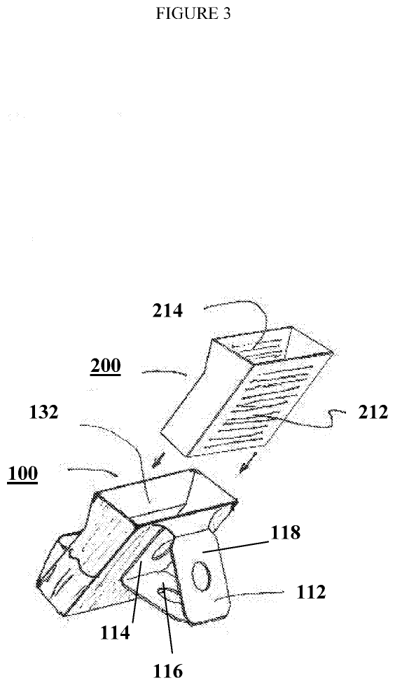

FIG. 3 is a perspective view of the portable multipurpose utility container in FIG. 2 with the multiple flat handles 112 configured as a triangular support. A liner 200, sized to also nest inside the container 100, is shown above the compartment 132 lined up and ready to be inserted into the compartment 132. The back of the liner's proximal wall 212 and the distal wall 214 may be corrugated or have ridges to provide a frictional surface for applying paint more evenly on a roller. Once the liner 200 is inserted into the compartment 100 it is ready to receive paint and be used as a paint tray. During use the multiple flat handles 112 may provide a means for securing the device to the user. For example, the multiple flat handles may be unfolded and flat handle 114 may be tucked in under a belt or wedged inside of a waist belt, tool belt of the user's pants, tight straps (i.e. chest strap), horizontally cut pockets, painter's apron etc. Correspondingly, when flat handles 114 and 116 or flat handles 114, 116 and 118 are folded tightly together and oriented downwardly they can be tucked in under a belt or wedged inside of a waist belt, tool belt of the user's pants, tight straps (i.e. chest strap), horizontally cut pockets, painter's apron etc. By using these alternative configurations of securing the device, the user may select the optimal distance to hang the device 100 during use. More specifically, flat handles 114 and 116 may be folded tightly together and tucked into the user's belt. In this configuration, flat handle 118 points upwardly and will cause the device 100 be positioned lower with respect to user's belt line. This can be the ideal/natural position for most users. Alternatively, when the flat handles are unfolded and only flat handle 114 is tucked in under a belt or tool belt, the container 100 will be positioned even lower with respect to user's belt line. This can be a preferred position for users with longer arms or when using a longer roller handle for better reach.

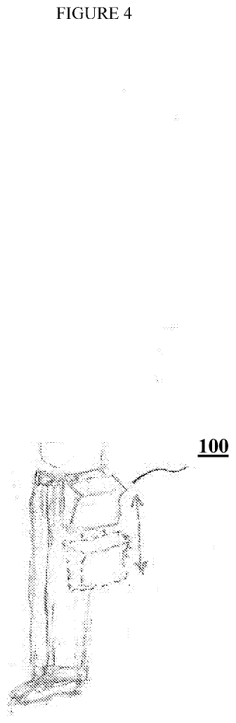

FIG. 4 is a side view of the device described in FIG. 3 showing two orientations of the device 100, hands free, with one or more of the flat handles secured to the belt of a user. An up and down arrow indicates positioning options with the lowest position depicted by dotted outline of the device 100.

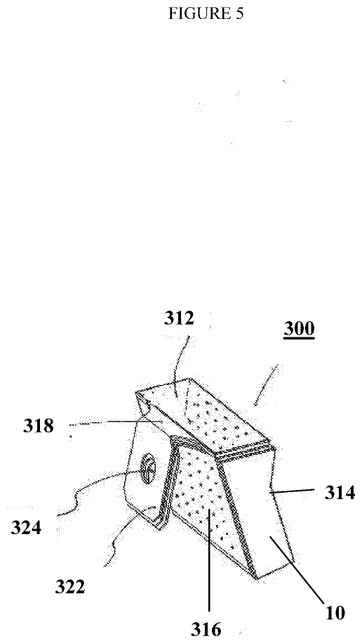

FIG. 5 is a perspective view of a cluster of identical portable multipurpose container liners 300 nested tightly together inside the compartment of the device 10. Each individual liner has a main compartment 312 with a textured rolling surface on the distal wall 314 and proximal wall 316 marked as series of small bumps on the inside forming indentations on the outside. Unlike the liner 200 of FIG. 3 these liners have wrist support section 318 and flat handle 322 with aperture 324 and in tandem they have sufficient rigidity to be used effectively for painting in pretty much the same way as the container in FIG. 1.

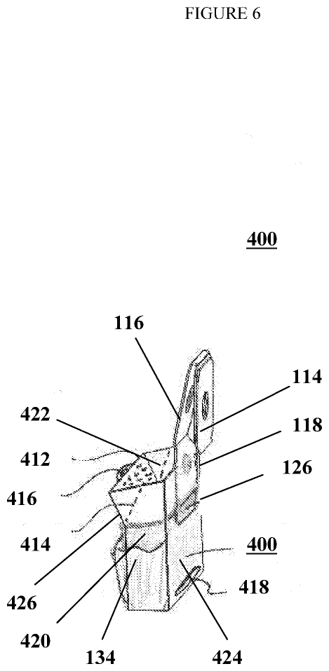

FIG. 6 is a perspective view of another embodiment of the present invention showing a flexible and/or semi-rigid portable multipurpose utility container 100 that contains a portable multipurpose utility container liner 400 inside. The container 100 has handles 114, 116 and 118, a wrist support section 126 and a side pocket 134 The flared lip section 412 of the distal wall 426 of the liner 400 extends above the compartment of the container to provide better access to the top section of liner 400 and facilitates the closing and opening process by keeping the pre-formed fold line 414 and pull tab 416 unrestricted. When the flared lip section 412 of the liner 400 is pushed inwardly or pulled in via pull tab 416, the top sections of both sidewalls 420 and 422 move in the outward direction and are forced to fold along preformed fold lines 414. As a result, the flared lip section 412 collapses inwardly to close tightly against the proximal wall 424 thus sealing the re-closable liner 400 to the extent that the substance inside will resist drying and spilling. To reopen the re-closable liner 400, the user needs merely to pull the pull tap 416 up and outward. In this configuration, a slot 418 is provided for inserting one or more flat handles 114, 116 or 118 to create a loop for securing the device to a support such as the rung of a ladder. The

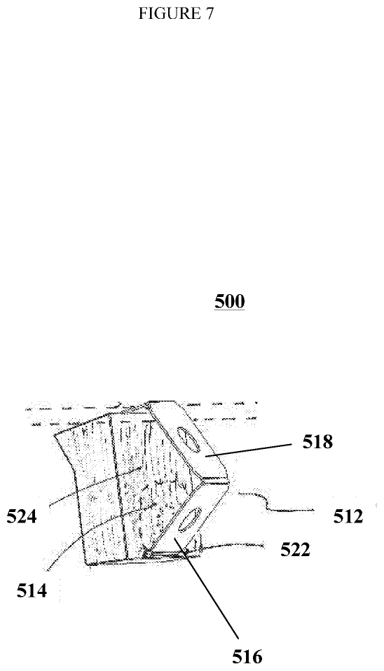

FIG. 7 is a perspective view of another embodiment of the present invention showing the device 500 hanging from a support (e.g., a ladder rung, scaffold bar, fence or the like). The top flat handle 514 of the foldable flat handles 514, 516 and 518 (i.e., 512) wraps around support with the flat handle 514 tucked into slot 522 on proximal wall 524.

FIG. 8 is a perspective view of one aspect of the present invention where the portable multipurpose utility container 600 with a base, 602 distal wall 614, proximal wall 604, right side wall 606 and left side wall 608. The distal wall has a lip 624 that may be folded over to cover the reservoir opening when not in use. Extending from the proximal wall 604 is a flat handle 612 having a horizontal or arched support section 616 extending outwardly and downwardly having an aperture midway along its length 618 and a locking means 622 near its end for securing the device when not in the hands of a user.

The specific features and functions of the above described components may be combined and/or transferable to other components. As an example, re-close-ability of the proposed inserts/liners can be added to the portable utility container in a similar manner as applied to the liner. There are many more embodiments possible as there are many more ways to carry and utilize them, but the true scope of the present invention will be best expressed in the claims to be appended in the follow-up regular patent application.

### Make and Use

All of the aspects of the present invention may be made as separate assembleable parts or are preferably made by form molding as a single part to avoid the additional costs of assembly.

When beginning a project the desired portable multipurpose utility container is selected. Once selected the user may consider using the device with or without a liner. If a liner is desired the liner is inserted into the portable multipurpose utility container. The desired fluid are then dispensed into the reservoir and appropriate tools for the job magnetically attached to either the interior or exterior of the container and the additional hardware or supplies dispensed in the side pockets if needed. If the project is a quick touch up, the portable multipurpose utility container that does not have side pockets may be used without a liner. The desired paint is dispensed in the reservoir and a paint brush with a magnetically susceptible frame attached to a magnet either on the exterior or interior of the reservoir. For a project that involves reaching into difficult places and requires equipment such as a ladder the portable multipurpose utility container with multiple handles may be beneficial. In circumstances where a longer paint roller may be required the handles may be unfolded and securely tucked over the waist belt of the user's pants adjusting the distance the container will hang from the user's hip. This allows for easy use of a longer paint roller. In this configuration the use of the device is essentially hands free. Allowing the user to climb a ladder with both hands.

When using the portable multipurpose utility container for smaller projects the wrist support section is placed over the wrist of the user and the user's thumb (or one or more digits of the hand) is inserted through the aperture in the flat handle. Each flat handle has a generally round aperture in its center for the user's thumb positioning the user's hand and wrist comfortably under the arched wrist support section. This provides control over the utility container during use, while allowing the thumb and fingers to still be able to grasp objects or to hold on to a ladder.

If the portable multipurpose utility container selected has a lip on the top of the distal wall, then this lip may be folded over to cover the top of the reservoir during movement, or when the container is not be used to prevent spillage from the reservoir or drying of the contents in the reservoir, if both hands are required to ascend a ladder for example, the handles of the container may be unfolded and the first handle may be inserted into the slot or upside down pocket or sleeve in the base of the proximal wall creating a loop that can secure the container to a ladder rung or a hook. Alternatively if it is desired to place the container on a surface the handles of the container may be unfolded and the first handle may be inserted into the slot or upside down pocket or sleeve in the base of the proximal wall creating a triangular base to prop up the container and prevent spilling.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

I claim:

1. A portable utility container comprising:
at least one compartment or reservoir having a base, a distal wall, a proximal wall, a left side wall and a right side wall, wherein said at least one compartment or reservoir is sized to receive, contain and/or dispense a substance or substances and to accommodate a variety of hand tools; and
a flat handle extending outwardly from the top of said proximal wall, said flat handle having a horizontal or arched wrist support section extending from said top of said proximal wall that continues outwardly and downwardly having at least one aperture about midway along its length and a locking means near the end of said flat handle for securing said portable utility container when not in a hand of a user; wherein said arched wrist support section having a depth greater than the diameter of a wrist of said user; and wherein said at least one aperture of said flat handle is sized and positioned to ergonomically accommodate a thumb or one or more digits of said user's hand thereby securing said portable utility container in a desired position during use.

2. A portable utility container comprising:
at least one compartment or reservoir having a base, a distal wall, a proximal wall, a left side wall and a right side wall, wherein said at least one compartment or reservoir is sized to receive, contain and/or dispense a substance or substances and to accommodate a variety of hand tools; and
an arched wrist support extending outwardly and downwardly from the top of said proximal wall and having a depth greater than the diameter of a wrist of a user;
one or more flat handles connected to said arched wrist support, wherein said one or more flat handles having at least one aperture about its center; and wherein said at least one aperture is sized and positioned to ergonomically accommodate a thumb or one or more digits of said user's hand thereby securing said portable utility container in a desired position during use.

3. The portable utility container according to claim 1, wherein said distal wall has a lip and wherein said lip can be folded over and cover the top of said compartment or reservoir to reduce spillage from said compartment or reservoir or drying of the contents of said compartment or reservoir during use or storage.

4. The portable utility container according to claim 2, wherein said distal wall has a lip and wherein said lip can be folded over and cover the top of said compartment or reservoir to reduce spillage from said compartment or reservoir or drying of the contents of said compartment or reservoir during use or storage.

5. The portable utility container according to claim 1, further comprising one or more magnets that are securely fastened to one or more of said base, distal wall, proximal wall, left side wall and right side wall for securing hand tools to said portable utility container.

6. The portable utility container according to claim 2, further comprising one or more magnets that are securely fastened to one or more of said base, distal wall, proximal wall, left side wall and right side wall for securing hand tools to said portable utility container.

7. The portable utility container according to claim 1, wherein said flat handle is a series of flat handles connected one to the other and can be folded upon one another to create a single flat handle or extended to form multiple flat handles.

8. A portable utility container liner comprising:
at least one compartment or reservoir having a base, a distal wall, a proximal wall, a left side wall and a right side wall, wherein said at least one compartment or reservoir is sized to receive, contain and/or dispense a substance or substances and to accommodate a variety of hand tools; and wherein said distal wall has a lip and wherein said lip can be folded over and cover the top of said compartment or reservoir to reduce spillage from said reservoir or drying of the contents of said compartment or reservoir during use or storage.

9. The portable utility container liner according to claim 8, further comprising at least one flat handle connected to the top of said proximal wall; said at least one flat handle having at least one aperture about its center and wherein said at least one aperture of said at least one flat handle is sized and positioned to ergonomically accommodate a thumb or one or more digits of a user's hand thereby securing said portable utility container liner in a desired position during use.

10. The portable utility container liner according to claim 8, wherein said lip is a cover flap having a front edge, a left side edge and a right side edge, wherein said cover flap allows said liner to be closed to reduce spillage during use or drying of the contents of said compartment or reservoir during use or storage.

11. The portable utility container liner according to claim 10, wherein said front edge, left side edge and right side edge may each independently have a tab for easy removal when said portable utility container liner is inserted within a portable utility container.

12. The portable utility container liner according to claim 8, wherein the edge of said lip is folded back upon itself forming a scraper.

13. The portable utility container according to claim 1, further comprising a scraping element secured or form molded into the top of said distal wall, said proximal wall, or both said distal wall and said proximal wall.

14. The portable utility container according to claim 2, further comprising a scraping element secured or form molded into the top of said distal wall, said proximal wall, or both said distal wall and said proximal wall.

15. The portable utility container according to claim 13, further comprising a snap clip along either or both the top of said front wall, said proximal wall, or both said distal wall and said proximal wall for securing a liner in place and for securing said scraping element.

16. The portable utility container according to claim 14, further comprising a snap clip along either or both the top of said front wall, said proximal wall, or both said distal wall and said proximal wall for securing a liner in place and for securing said scraping element.

17. A flexible portable utility container comprising:
at least one compartment or reservoir having a base, a distal wall and a proximal wall, wherein said at least one compartment or reservoir is sized to receive a portable utility container liner, and having at least one flat handle connected to the top of said proximal wall having at least one aperture about its center and wherein said at least one aperture of said flat handle is sized and positioned to ergonomically accommodate a thumb or one or more digits of a user's hand thereby securing said flexible portable utility container in a desired position during use.

18. The portable utility container according to claim 1, wherein said substance or substances is water, paint, stain, lacquer, glue, leveling compound, drywall joint compound, spackling paste, wood putty or cleaning solution.

19. The portable utility container according to claim 2, further comprising a slot along and about the middle of the base of said proximal wall for inserting one or more of said gripping sections forming a loop for securing said portable utility container to a ladder, step stool, rain gutter, pipe, saw horse or a length of wood.

20. The flexible portable utility container according to claim 17, further comprising a slot or sleeve about the middle of the base of said proximal wall, for inserting one or more of said flat handles to form a loop for securing said portable utility container to a ladder, step stool, rain gutter, pipe, saw horse or a length of wood.
